(19) United States
(12) Patent Application Publication
(10) Pub. No.: US 2016/0109027 A1
(43) Pub. Date: Apr. 21, 2016

(54) VALVE SEAT AND VALVE DISC WITH CASCADED GEOMETRIES

(71) Applicant: General Electric Company, Schenectady, NY (US)

(72) Inventors: Axelle Le Jossec, Warsaw (PL); Krzysztof Andrzej Woszczak, Warsaw (PL); Robert Jacek Zreda, Warsaw (PL)

(21) Appl. No.: 14/239,357

(22) PCT Filed: Jun. 19, 2013
(86) PCT No.: PCT/PL2013/000083

§ 371 Date: Feb. 18, 2014

(51) Int. Cl. F16K 1/38; F16K 25/00; F16K 1/42

(52) U.S. Cl. CPC F16K 1/385; F16K 1/42; F16K 25/00

(57) ABSTRACT

Disclosed are a valve seat apparatus and valve disc apparatus. The valve seat can include a substantially hollow seat interior. The substantially hollow seat interior can also define a substantially frusto-conical seat cavity with a radial axis. The substantially hollow seat interior can have first and second wall sections, with the second wall section being aligned at a smaller angle relative to the radial axis than the first wall section. The valve disc can include a substantially frusto-conical valve body with a radial axis. The valve body can include first and second disc surfaces each aligned at an angle relative to the radial axis. The second disc surface can have an angle relative to the radial axis that is smaller than that of the first disc surface.

### BACKGROUND

Embodiments of the present disclosure relate generally to globe-style control valve assemblies.

Generally, a globe-style control valve assembly includes at least one valve disc and seat sub-assembly located inside the valve body—single ported valve. A globe-style control valve can regulate the rate of fluid flow by changing the position of the valve disc from a closed to a “wide open” position with the use of an actuator force. In high temperature applications, the valve can include oxide resistant alloys with varying coefficients of thermal expansion. If, for example, a valve seat is manufactured from a material different from a corresponding valve disc, or if the valve seat is made of the same material as the valve disc but it is installed in the valve body of a different material, then a thermal force resulting from non-uniform radial thermal growth of both parts during transient and steady state conditions can be exerted on the seat and disc surfaces.

In this case, the value of the friction force between the seat and disc is directly proportional to the thermal force, seating angle and the friction coefficient between valve seat and disc. A valve disc can become inseparable from a valve seat if the maximum available actuator force is less than the sum of pressure loads being exerted on the internal valve components and the friction force between the valve seat and disc. This phenomenon is sometimes known as “thermal pinching.”

By way of example, FIG. 1 demonstrates a relationship between thermal force acting on a simple valve seat 2 when a simple valve disc 4 is seated thereon. In high temperature fluid flow applications, simple valve disc 4 may be difficult to disengage from simple valve seat 2 if the action of a thermal force between each component causes a static frictional force to be greater than actuating forces which would otherwise disengage simple valve disc 4 from simple valve seat 2. The effects of this problem, sometimes known as “thermal pinching,” can increase if an angle θ relative to the radial axis R, at which simple valve seat 2 is aligned, increases. The magnitude of frictional force can be directly proportional to the normal component vector 12 of a thermal force 10 caused by expansion of simple valve disc 4 in high temperature applications. As is shown in FIG. 1, thermal force 10 is the sum of two vector components, one of which is a normal thermal component 12 perpendicular to the profile of simple valve seat 2 aligned at angle θ to radial axis R. The relationship between angle θ and normal thermal component 12 can be expressed as:

(Normal Thermal Component)=(Thermal Force)(sin θ)

Thus, normal thermal component 12 can increase as angle θ increases, even if the magnitude of thermal force 10 remains constant. Increasing the value of angle θ relative to radial axis R therefore can also result in greater frictional force and increased thermal pinching.

Although thermal pinching could be reduced by reducing the angle of a valve seat profile relative to radial axis R, FIG. 2 demonstrates that this approach can also cause negative effects on flow stability of a fluid through a valve. FIG. 2 depicts a first valve seat profile 6 with angle relative to radial axis R, and a second valve seat profile 8 with angle θ₂ relative to radial axis R. In both valve seat profiles 6, 8, fluid flow through valve lower section 20 is stable. However, smaller angle θ₁ of first valve profile 6 can result in flow detachment 30 in valve upper section 22. In contrast, greater angle θ₂ of valve profile 8 can enable stable fluid flow even in valve upper section 22. However, several other variables can also affect fluid flow through a valve, including operating conditions and valve lift.

Thus, valve seats aligned at a large angle relative to radial axis R can potentially improve fluid flow stability, but can also increase sticking caused by thermal forces in high temperature applications when a valve disc is seated on a valve seat. Decreased flow stability, however, can potentially lead to other problems such as excessive equipment wear, noisy operation, lower life cycle of components, and reduced reliability.

### SUMMARY

At least one embodiment of the present disclosure is described below in reference to its application in connection with valve seat and disc apparatuses. However, it should be apparent to those skilled in the art and guided by the teachings herein that embodiments of the present invention are applicable to any piece of equipment or system in which thermal pinching impairs the separation of mechanical components.

A first aspect of the present disclosure provides a valve seat apparatus. The valve seat can have a substantially hollow seat interior. The substantially hollow seat interior can define a substantially frusto-conical seat cavity having a radial axis. A substantially hollow seat interior can include first and second wall sections, where the first wall section of the substantially hollow seat interior can be aligned at a first angle relative to the radial axis, and the second wall section can be aligned at second angle relative to the radial axis. The second angle relative to the radial axis can be smaller than the first angle relative to the radial axis.

A second aspect of the present disclosure provides a valve disc apparatus. The valve disc apparatus can include a substantially frusto-conical valve body having a radial axis. The body of the valve disc apparatus can also include first and second surface sections, aligned at first and second angles relative to the radial axis, respectively. The second angle relative to the radial axis can be smaller than the first angle relative to the radial axis.

A third aspect of the present disclosure provides a further valve seat apparatus. The valve seat can include a substantially hollow seat interior, and the interior can define a substantially frusto-conical seat cavity having a radial axis. A substantially hollow seat interior can include first, second, and third wall sections, and each of the three wall sections can be aligned at first, second, and third angles relative to the radial axis, respectively. The second wall section can be positioned between the first and third wall sections, and its corresponding second angle relative to the radial axis can be smaller than the both first and third angles relative to the radial axis. A third aspect of the disclosure can also include inlet and outlet transition sections, which can be interposed between the second and third wall sections and the first and second wall sections, respectively. The inlet and outlet transition sections can have angles relative to the radial axis that are smaller than the first and third angles with respect to the radial axis, yet larger than the second angle with respect to the radial axis.

### BRIEF DESCRIPTION OF THE DRAWINGS

These and other features of the disclosed apparatus will be more readily understood from the following detailed description of the various aspects of the apparatus taken in conjunction with the accompanying drawings that depict various embodiments of the invention, in which:

FIG. 1 is a diagram illustrating the relationship between thermal force and the angle of a valve seat.

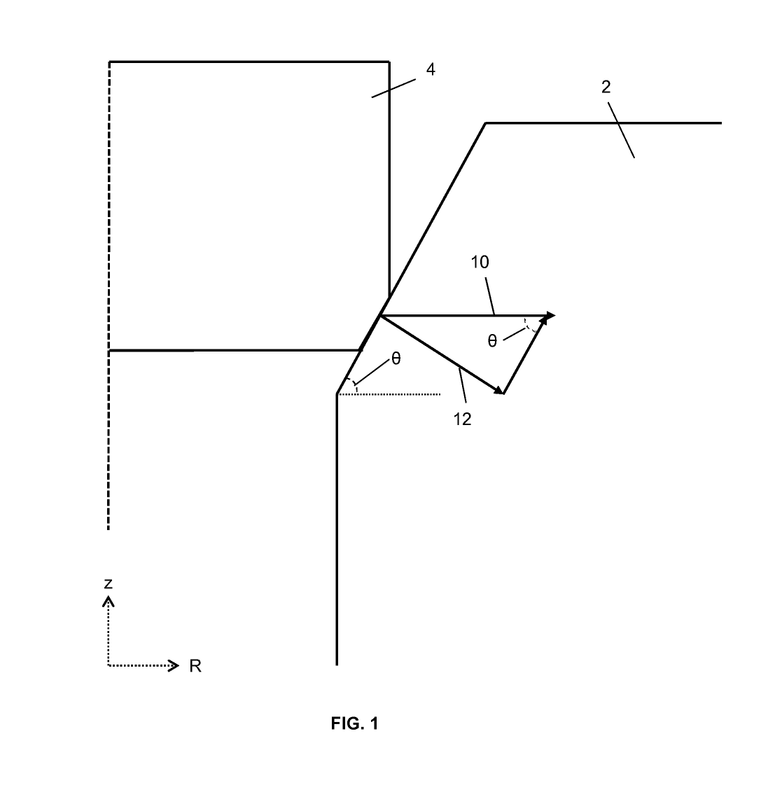

FIG. 2 is a diagram illustrating the relationship between flow stability and the angle of a valve seat.

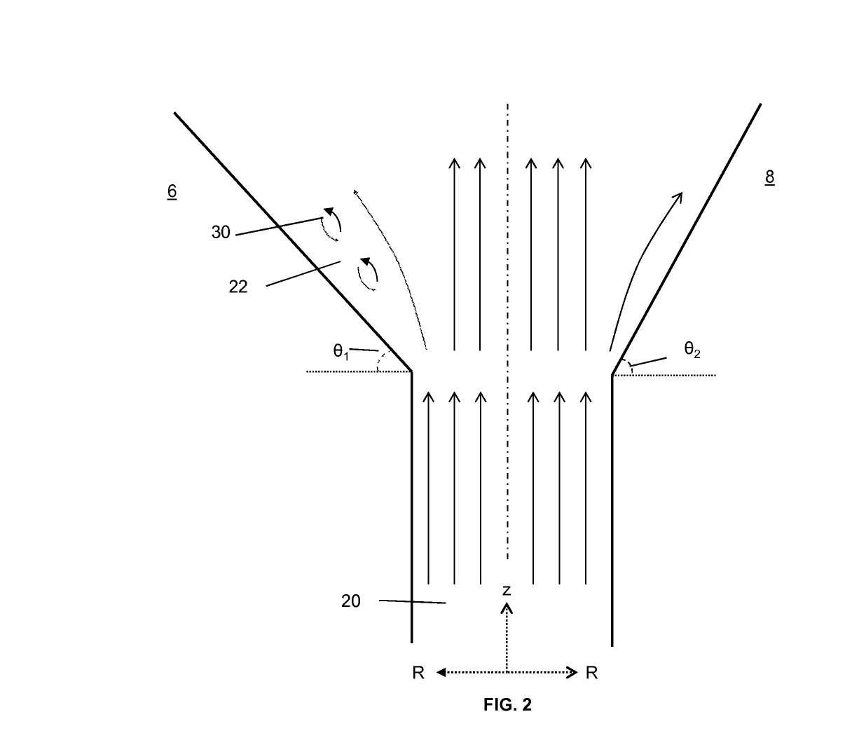

FIG. 3 is a schematic of a valve seat configured to include a variable angle, and a valve disc configured to include surface sections at variable angles.

FIG. 4 is a schematic of a valve disc disengaged from a valve seat.

FIG. 5 is a schematic of a valve seat wall geometry with inlet and outlet transition sections.

FIG. 6 is a schematic of a valve disc surface geometry with two disc transition sections between three disc surfaces.

It is noted that the drawings are not necessarily to scale. The drawings are intended to depict only typical aspects of the disclosure, and therefore should not be considered as limiting its scope. In the drawings, like numbering represents like elements between the drawings.

### DETAILED DESCRIPTION OF PREFERRED EMBODIMENTS

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely exemplary.

When an element or layer is referred to as being “on,” “engaged to,” “disengaged from,” “connected to” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “inner,” “outer,” “beneath”, “below”, “lower”, “above”, “upper,” “inlet,” “outlet” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

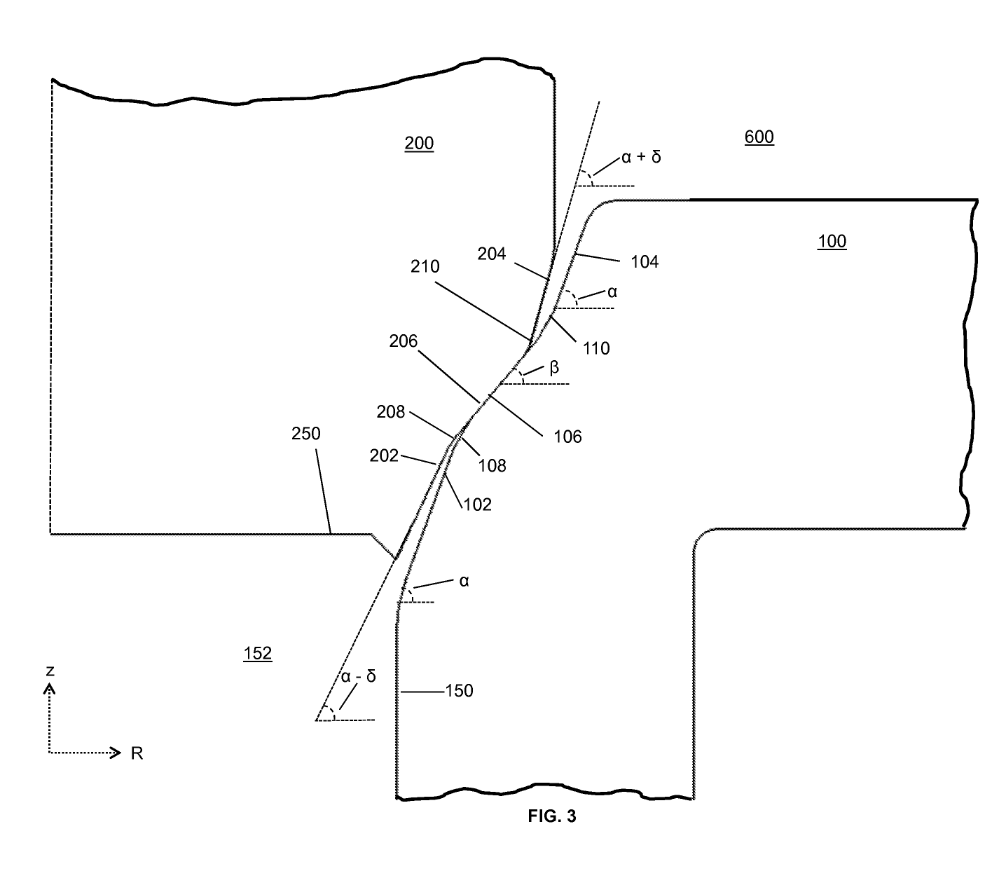

The previously described relative disadvantages and advantages of each design can be overcome by aligning first wall section 102 at a larger angle α to radial axis R than the angle β of second wall section 106, an example of which is shown in FIG. 3. This design can provide an alternating or “cascaded” geometry which can allow fluid flow from valve 600 through seat cavity 152 to remain stable, yet can also reduce the friction force between valve seat 100 and valve disc 200 by reducing the normal (perpendicular to the seat surface) component of thermal force during uneven thermal growth of both parts. Cascading wall sections on seat interior 150 of valve seat 100 can offer these advantages whether used with a similarly cascaded valve disc 200 or a conventional valve disc (not shown).

FIG. 3 discloses an embodiment of a valve seat 100 being engaged by an embodiment of valve seat 200. Problems associated with “thermal pinching,” can be mitigated or eliminated by using valve seat 100 designed with an alternating angle, identified in this disclosure as a cascaded geometry. For example, valve seat 100 can include a first wall section 102 which can be aligned at a first angle, α, relative to radial axis R. Valve seat 100 can further include a second wall section 106 that can be aligned at a second angle, β, to radial axis R.

Valve seat 100 can include substantially hollow seat interior 150, and hollow seat interior 150 can thereby define a seat cavity 152, which can have any geometry applicable to a particular system, but is depicted as having substantially frusto-conical shape. Seat cavity 152 can have a central axis z along the length of valve 600 or a pipe, and a radial axis R extending outwardly from the center of seat cavity 152. The figure depicts valve disc 200 as being engaged to valve seat 100.

Along the substantially hollow seat interior 150 can be located various wall sections, including first section 102 located below a second section 106, which can be further located below a third section 104. The geometry of valve seat 100 can be varied to omit certain wall sections, such the third section 104, to reduce the geometric complexity of valve seat 100. Valve seat 100 can optionally include transition sections 108 and 110 to provide a more complex geometry and improve stability of fluid flow from valve 600 through seat cavity 152 if valve disc 200 is disengaged from valve seat 100. Valve seat 100 can further include exterior geometric features, such as bolts and contoured exterior edges (not shown) which can engage machinery and components.

Valve disc 100 shown in FIG. 3 is depicted as including third wall section 104, which can be located above second wall section 106, such that second wall section 106 can positioned between first wall section 102 and third wall section 104. Third wall section 104 can also be aligned at an angle α relative to radial axis R that is greater than the angle β relative to radial axis R of second wall section 104. Although third wall section 104 in FIG. 3 is shown to have the same angle α relative to radial axis R as first wall section 102, further embodiments where first wall section 102 and third wall section 104 are at different angles relative to radial axis R are also contemplated.

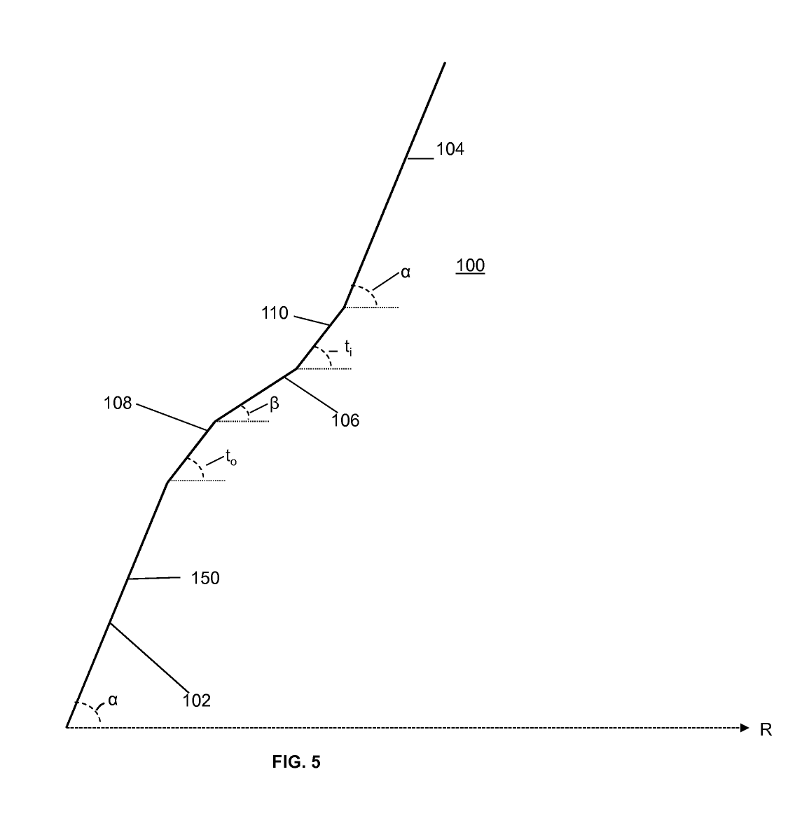

If valve seat 100 includes a third wall section 104, a further inlet transition section 110 shown in FIG. 3 can also improve fluid flow through valve 600 if valve disc 200 is disengaged from valve seat 100. Inlet transition section 110 can be aligned such that it has an angle relative to radial axis R that is greater than angle β of the second wall section relative to radial axis R yet smaller than angle α of the third wall section 106 relative to radial axis R. Inlet transition section 110 is discussed further in connection with FIG. 5, below.

Valve seat 100 can also include an outlet transition section 108 above first wall section 102 but below second wall section 106. This additional feature is depicted in the schematic of FIG. 3. Similar to the above-described inlet transition section 110, outlet transition section 108 can improve fluid flow stability if valve disc 200 is disengaged. Outlet transition section 108 can be aligned such that it has an angle relative to radial axis R that is greater than angle β of the second wall section relative to radial axis R yet smaller than angle α of the first wall section relative to radial axis R. Further designs and embodiments of outlet transition section 108 are contemplated, and discussed further in connection with FIG. 5, below. Either or both of outlet transition section 108 and inlet transition section 110 can be designed with a straight edge, a curve, or other geometry applicable to the design of valve seat 100 and/or valve disc 200.

The first and third angles α relative to radial axis R, as well as the second angle β relative to radial axis R, can be designed to have specific ranges of angular values. For example, a first or third angle α relative to radial axis R can have a value of in the range of approximately 60° to approximately 75° with respect to radial axis R. By similar example, a second angle β relative to radial axis R can have a value in the range of approximately 50° to approximately 60° with respect to radial axis R.

To reduce the contact area between valve seat 100 and valve disc 200 and thereby increase both contact pressure and subsequently valve sealing capability, second wall section 106 can have a length that is shorter than either or both of first wall section 102 and third wall section 104. Reducing the length of second wall section 106 relative to first wall section 102 and third wall section 104 can also reduce the risk of flow detachment from the valve seat at the seat to disc contact region.

At least some of the above-described advantages offered by a cascaded geometry in valve seat 100 can be improved by using valve disc 200 with valve seat 100, which can have a similarly cascaded geometry. Valve disc 200 can include first disc surface 202 that can be aligned at a first disc angle (α−δ) to radial axis R. The first disc angle can be modified by a corrective angular value δ to aid with fluid flow speed and stability when valve disc 200 is either engaged with or disengaged from valve seat 100. Valve disc 200 can further include second disc surface 206 aligned at a second disc angle β. This angular magnitude can allow second disc surface 206 to contact valve seat 100 at second wall section 106.

The disclosure also relates to a valve disc 200 with a cascaded geometry, and FIG. 3 also depicts a schematic of an embodiment of valve disc 200. An embodiment of valve disc 200 can include a substantially frusto-conical valve body 250 with a center along axis z and a radial axis R originating therefrom. Valve body 250 can include a first disc surface 202 aligned at a first angle (α−δ) relative to radial axis R. The first angle relative to radial axis R can be modified by a corrective angular value δ to aid with fluid flow speed and stability when valve disc 200 is either engaged with or disengaged from a valve seat 100. Valve body 250 can further include a second disc surface 206 aligned at a second angle β relative to radial axis R. The second angle β can be smaller than the first angle (α−δ) relative to radial axis R, such that second disc surface 206 of valve body 250 can contact a valve seat 100 with a cascaded geometry. In addition, valve disc 200 can be dimensioned to prevent first disc surface 202 from contacting any section of valve seat 100.

Valve disc 200 can also optionally be provided with a third disc surface 204. Third disc surface 204 can be aligned at a third angle (α−δ) relative to radial axis R. The corrective angular value δ can be used to modify the third angle of third disc surface 204. Modifying the third angle can aid with fluid flow speed and stability when valve disc 200 is either engaged with or disengaged from valve seat 100. The third angle (α+δ) relative to radial axis R can be greater than the second angle β relative to radial axis R to prevent third disc surface 204 from contacting any section of valve seat 100. In addition, the third angle (α+δ) relative to radial axis R can be greater than the first angle (α−δ) relative to radial axis R if corrective angular value δ greater than zero.

The first angle (α−δ) of first disc surface 202 can be dimensioned to physically separate first disc surface 202 from contacting valve seat 100 when valve disc 200 engages valve seat 100. Similarly, if a third disc surface 204 is provided on valve disc 200, the angle of third disc surface 204 can be dimensioned to physically separate third disc surface 204 from valve seat 100 when valve disc 200 engages valve seat 100. Restricting contact between valve disc 200 and valve seat 100 only to second disc surface 206 assists in providing adequate valve sealing capabilities, while improving the valve's ability to open and fluid flow through the valve 600 if valve disc 200 does not engage valve seat 100.

Similar to valve seat 100 discussed previously, valve disc 200 can include first and second transition surfaces 208, 210, located above and/or below second disc surface 206. If transition surface 208 is interposed between the second disc surface 206 and the first disc surface 202, the transition surface 208 can be aligned at an angle relative to radial axis R that is less than the first angle (α−δ) relative to radial axis R but greater than the second angle β relative to radial axis R.

Additionally or alternatively, a transition surface 210 can be interposed between the second disc surface 206 and the third disc surface 204. Transition surface 210 can be aligned at an angle relative to radial axis R that is less than the third angle (α+δ) relative to radial axis R and greater than the second angle β relative to radial axis R. Transition surfaces 208, 210 can be in the form of a straight edge, curve, contoured shape, or geometry capable of interface with an embodiment of valve seat 100 and/or valve disc 200.

A Valve disc 200 with cascaded geometry can be used with valve seat 100, which can have a similarly cascaded geometry. For example, a first disc surface 202 and second disc surface 206 of disc body 250 can engage valve seat 100, which can have a first wall section 102 aligned at a first wall angle α relative to radial axis R and a second wall section 106 aligned at a second wall angle β relative to radial axis R. The second wall angle β of valve seat 100 can be smaller than the first wall angle α of valve seat 100, such that the first disc surface 202 can be physically separated from first wall section 102 of valve seat 100.

Although the embodiment depicted in FIG. 3 is shown to have flat angled surfaces for each of valve seat 100 and valve disc 200, other compatible geometries for any surface of each apparatus are within the scope of this disclosure. For example, second surface 206 of valve disc body 250 and second wall section 106 of valve seat interior 150 can be designed with a spherically contoured shape, or other shape. In the case of such alternatives, second angle β can represent a spherical or other alternative angle of second surface 206 and/or second wall section 106 with respect to radial axis R. Similar modifications to first wall section 102, third wall section 104, first surface section 202, third surface section 204, inlet transition section 108, outlet transition section 110, and transition surfaces 208, 210 are also considered to be within the scope of this disclosure.

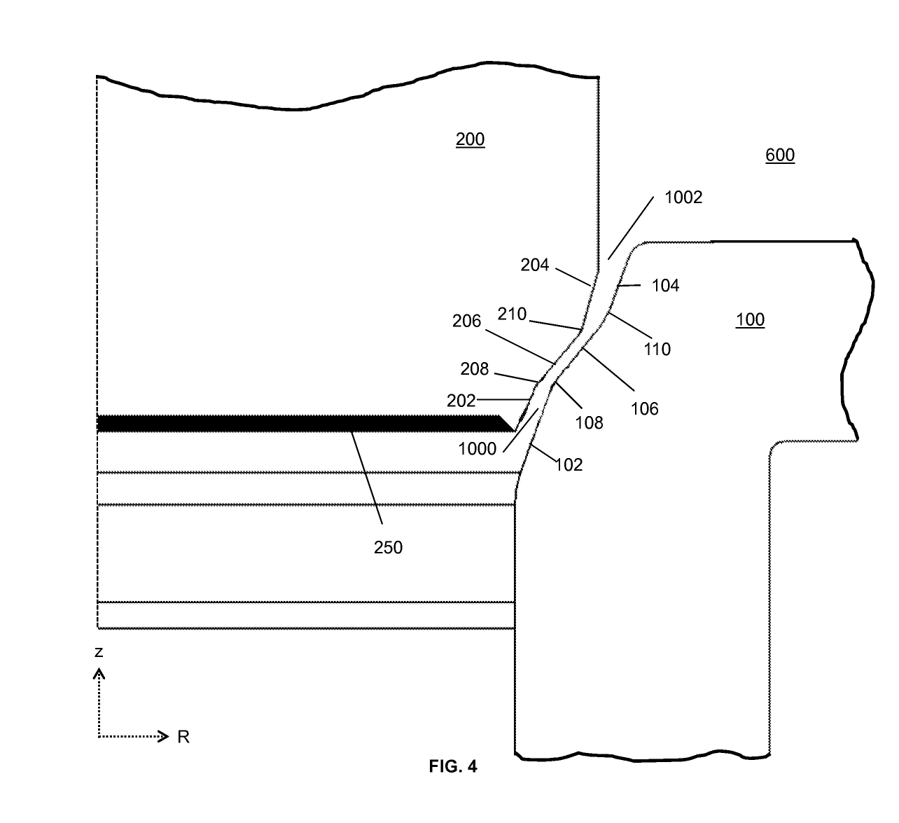

FIG. 4 shows an embodiment of valve disc apparatus 200 disengaged from an embodiment of valve seat apparatus 100. In this configuration, a fluid (not shown) is permitted to flow through valve 600 between valve seat 100 and valve disc 200. If a cascaded geometry is used for or both of valve seat 100 and valve disc 200, the cascaded geometry can form confusor 1002 and diffuser 1000 flow profiles at low control valve lifts. For the purposes of this disclosure, a “confusor” refers to a section of a valve at which fluid is permitted to flow more densely and with more velocity and through a region of less surface area, as exemplified by the space of valve 600 between third wall section 104 of valve seat 100 and third surface section 204 of valve disc 200. A “diffusor,” by contrast, refers to a section of a valve at which fluid is permitted to flow less densely and with less velocity through a region of greater surface area, as exemplified by the space of valve 600 between first wall section 102 of valve seat 100 first surface section 202 of valve disc 200.

FIG. 5 provides a schematic of a surface geometry of an embodiment of valve seat 100 and valve seat interior 150, which depicts inlet transition section 110 and outlet transition section 108 in detail. In the schematic, a first wall section 102 of valve seat interior 150 is aligned at a first angle a with respect to radial axis R. Above and connected to first wall section 102 can be provided outlet transition section 108, which can be aligned at outlet transition angle t₀ with respect to radial axis R. Inlet transition angle t₀ can be of lesser magnitude with respect to radial axis R than first angle α. Second wall section 106 can be above and connected to outlet transition section 108, which can be aligned at second angle β with respect to radial axis R. Second angle β can be of lesser magnitude with respect to radial axis R than both first angle α and outlet transition angle t₀.

An inlet transition section 110 can be above and connected to second wall section 106. Inlet transition section 110 can also be aligned at inlet transition angle tᵢ with respect to radial axis R. Inlet transition angle tᵢ can be of lesser magnitude with respect to radial axis R than first angle α, but greater in magnitude with respect to radial axis R than second angle β. A third wall section 104 can also be above and connected to inlet transition section 110. Third wall section 104 can be aligned at angle α with respect to radial axis R, or can be aligned at a different angle greater than second angle β.

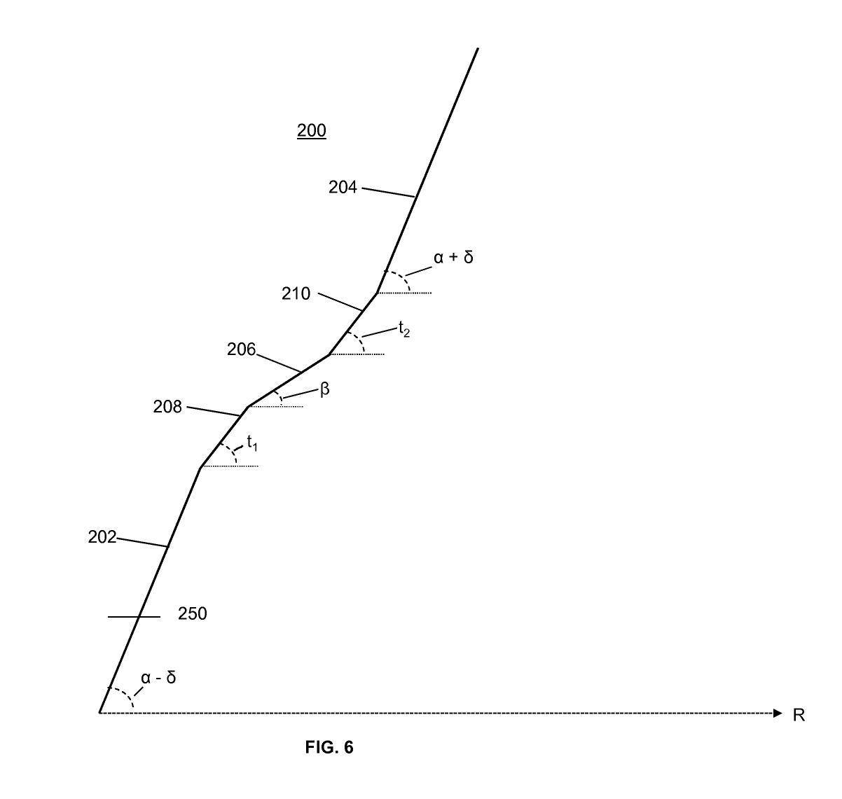

FIG. 6 provides a schematic of a surface geometry for an embodiment of a valve disc apparatus 200, which depicts first and second disc transition surfaces 208, 210 in greater detail. In the schematic, first disc surface 202 of valve body 250 is aligned at a first angle (α−δ) with respect to radial axis R. First transition surface 208 can be above and connected to first disc surface 202, with first transition surface 208 being capable of alignment at first transition angle t₁ with respect to radial axis R. First transition angle t₁ can be of lesser magnitude with respect to radial axis R than first angle (α−δ). Second disc surface 206 can be positioned above both first disc surface 202 and first transition surface 208, and is capable of alignment at second angle β with respect to radial axis R. Second angle β can be of lesser magnitude with respect to radial axis R than both first angle (α−δ) and first transition angle t₁.

A second transition surface 210 can alternatively or additionally be located above second disc surface 206. Second transition surface 210 can be aligned at second transition angle t₂ with respect to radial axis R, and transition angle t₂ is capable of having a greater magnitude than second angle β. A third disc surface 204 can be connected to second disc surface 206 directly or through second transition surface 210. Third disc section 204 can be aligned at third angle (α+δ) with respect to radial axis R, or can be aligned at a different angle greater than second angle β. The variable δ can represent a corrective angular value equal to or greater than zero, which can cause valve disc 200 to have an angular differential between first disc section 202 and third disc section 204, if desired.

The embodiments of apparatuses discussed in this disclosure can offer several technical and commercial advantages. An advantage that may be realized in the practice of some embodiments of the described apparatuses is improved flow stability of a fluid (not shown) through valve 600 when valve disc 200 is disengaged from valve seat 100. A further advantage that may be realized in some embodiments of the described apparatuses includes improvements to valve reliability and lower risk of inoperability when one or more embodiments of the apparatuses herein disclosed are used, as compared to other designs. An additional advantage that can be available in some embodiments of the described apparatuses can include reduced service costs for equipment and systems that include a valve because the risk of sticking due to thermal pinching can be reduced or eliminated, even in high temperature steam applications.

Using a contemplated embodiment of valve seat 100 or valve disc 200 can also reduce unpleasant noise in mechanical and fluid systems, which can result from flow instabilities when valve is open. The disclosed embodiments can also reduce or eliminate vibratory action of valve disc 200, which can be caused by flow instability, as compared to valve discs which do not include the features provided in this disclosure. Embodiments of valve disc 200 and valve seat 100 can also have a greater life cycle than analogous components, and furthermore can increase the life cycle of other system components by reducing wear on internal valve parts.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or” comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A valve seat comprising:
a valve seat having a substantially hollow seat interior, wherein the substantially hollow seat interior defines a substantially frusto-conical seat cavity having a radial axis, and the substantially hollow seat interior further comprises;
a first wall section of the substantially hollow seat interior aligned at a first angle relative to the radial axis; and
a second wall section of the substantially hollow seat interior aligned at a second angle relative to the radial axis, wherein the second angle relative to the radial axis is smaller than the first angle relative to the radial axis.

2. The valve seat of claim 1, wherein the substantially hollow seat interior further comprises a third wall section aligned at a third angle relative to the radial axis, and wherein the second wall section is positioned between the first wall section and the third wall section.

3. The valve seat of claim 2, further comprising an inlet transition section interposed between the third wall section and the second wall section, wherein the inlet transition section has an angle relative to the radial axis that is less than the third angle relative to the radial axis and greater than the second angle relative to the radial axis.

4. The valve seat of claim 2, wherein the third wall section is dimensioned to prevent the third wall section from contacting a valve disc.

5. The valve seat of claim 1, wherein the first angle is between approximately 60° to approximately 75° with respect to the radial axis.

6. The valve seat of claim 1, wherein the second angle is between approximately 50° to approximately 60° with respect to the radial axis.

7. The valve seat of claim 1, further comprising an outlet transition section interposed between the first wall section and the second wall section of the substantially hollow seat interior, wherein the outlet transition section has an angle relative to the radial axis that is less than the first angle relative to the radial axis and greater than the second angle relative to the radial axis.

8. The valve seat of claim 1, wherein the second wall section has a length that is less than a length of the first wall section.

9. The valve seat of claim 1, wherein the second wall section contacts one surface of a valve disc, wherein the valve disc comprises:
a first disc surface aligned at a first disc angle relative to the radial axis; and
a second disc surface aligned at a second disc angle relative to the radial axis, wherein the second disc angle is smaller than the first disc angle, and a second disc surface of the valve disc contacts the valve seat.

10. A valve disc comprising:
a substantially frusto-conical valve body having a radial axis;
a first disc surface aligned at a first angle relative to the radial axis; and
a second disc surface aligned at a second angle relative to the radial axis, wherein the second angle relative to the radial axis is smaller than the first angle relative to the radial axis.

11. The valve disc of claim 10, wherein valve body is dimensioned to allow the second disc surface to contact a valve seat and prevent the first disc surface from contacting the valve seat.

12. The valve disc of claim 10, further comprising a third disc surface aligned at a third angle relative to the radial axis, wherein the third angle is greater the second angle.

13. The valve disc of claim 12, further comprising a transition disc surface interposed between the second disc surface and the third disc surface, wherein the transition surface has an angle relative to the radial axis that is less than the third angle relative to the radial axis and greater than the second angle relative to the radial axis.

14. The valve disc of claim 12, wherein the third disc surface is dimensioned to remain physically separated from a valve seat.

15. The valve disc of claim 14, wherein the third angle is greater than the first angle.

16. The valve disc of claim 10, wherein the first disc surface is dimensioned to remain physically separated from a valve seat.

17. The valve disc of claim 16, wherein the valve seat comprises a first wall section aligned at a first wall angle to the radial axis and a second wall section at a second wall angle to the radial axis that is smaller than the first wall angle, and the first disc surface is physically separated from the first wall section of the valve seat.

18. The valve disc of claim 10, wherein the valve disc is dimensioned to form a confusor at a valve inlet and a diffusor at a valve outlet in response to fluid flow between the valve disc and a valve seat.

19. The valve disc of claim 10, further comprising a transition surface interposed between the first disc surface and the second disc surface, wherein the transition surface has an angle relative to the radial axis that is less than the first angle relative to the radial axis and greater than the second angle relative to the radial axis.

20. A valve seat comprising:
a valve seat with a substantially hollow seat interior, wherein the substantially hollow seat interior defines a substantially frusto-conical seat cavity having a radial axis, and the substantially hollow seat interior further comprises:
a first wall section of the substantially hollow seat interior aligned at a first angle relative to the radial axis; and,
a second wall section of the substantially hollow seat interior aligned at a second angle relative to the radial axis, wherein the second angle relative to the radial axis is smaller than the first angle relative to the radial axis;
a third wall section aligned at a third angle relative to the radial axis, wherein the second wall section is positioned between the first wall section and the third wall section;
an inlet transition section interposed between the third wall section and the second wall section, wherein the inlet transition section has an angle relative to the radial axis that is less than the third angle relative to the radial axis and greater than the second angle relative to the radial axis; and
an outlet transition section interposed between the first wall section and the second wall section of the substantially hollow seat interior, wherein the outlet transition section has an angle relative to the radial axis that is less than the first angle relative to the radial axis and greater than the second angle relative to the radial axis.
